(19) United States
(12) Patent Application Publication
(10) Pub. No.: US 2005/0211013 A1
(43) Pub. Date: Sep. 29, 2005

(54) Antivibration device for vehicle and link rod comprising such a device

(75) Inventors: Khalid Aazizou, La Chapelle Du Noyer (FR); Laurent Compain, Beaugency (FR)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HUTCHINSON, Paris (FR)

(21) Appl. No.: 11/091,218

(22) Filed: Mar. 28, 2005

(30) Foreign Application Priority Data
Mar. 29, 2004 (FR) FR 04 03224

(51) Int. Cl. H01H 51/22

(52) U.S. Cl. 74/588

(57) ABSTRACT

Antivibration device comprising an external tubular armature and an internal armature, placed in the external armature, two elastomer bodies placed either side of the internal armature, in the external armature, the elastomer bodies being secured to a first armature. The elastomer body is also secured to an intermediate armature which is adjacent to the second armature and which is suitable for bearing against the said second armature when the first and second armatures move one against the other in an alignment corresponding to a compression of the said elastomer body, each intermediate armature being free relative to the second armature.

### FIELD OF THE INVENTION

The present invention relates to antivibration devices for vehicles, such as engine supports, antivibration sleeves for torque take-up link or similar, exhaust line supports, or other, and a rod comprising such devices.

More particularly, the invention relates to an antivibration device comprising a first annular armature surrounding a second armature, the armatures defining between them a free space, at least a first elastomer body being placed at least partially in the free space between the first and second armatures, the first body being secured to the first armature, the first elastomer body also being secured to a first intermediate armature which is adjacent to the second armature.

### SUMMARY OF THE INVENTION

The purpose of the present invention is to further perfect the antivibration devices of this type, particularly by improving their service life.

For this purpose, according to the invention, an antivibration device of the type in question is characterized in that the intermediate armature has a bearing surface suitable for bearing against a bearing surface of complementary shape belonging to the second armature, and the intermediate armature being suitable for bearing against the said second armature when the first and second armatures move relative to one another in a first direction, in a first alignment corresponding to a compression of the said first elastomer body, the said first intermediate armature being free relative to the second armature and being suitable for separating itself from the said second armature when the first and second armatures move relative to one another in a second alignment opposite the said first alignment.

Thanks to these arrangements, at least the first elastomer body sustains only compression strains and no traction strain, which increases its service life. In addition, the intermediate armature may, where necessary, increase the axial rigidity of the device, in the direction of stress, that is to say its rigidity parallel to the axis X, but also makes it possible to have a greater range of linearity, that is to say to have a substantially stable rigidity of the device for various stresses.

In various embodiments of the method according to the invention, it may be possible to have recourse also to one and/or other of the following dispositions:
the device also comprises a second elastomer body which is placed in the free space between the first and second armatures, the first and second elastomer bodies being placed respectively either side of the second armature, the said second body being secured to the first armature and to a second intermediate armature which is adjacent to the second armature and which is suitable for bearing against the said second armature when the first and second armatures move relative to one another in the said second alignment, the said second intermediate armature being free relative to the second armature and being suitable for separating itself from the said second armature when the first and second armatures move relative to one another in the first alignment;
the intermediate armature is in contact with the second armature in the absence of external stress;
a clearance is made between the intermediate armature and the second armature, in the absence of external stress;
the first and second armatures are connected together also by third and fourth elastomer bodies which are housed at least partly in the free space between the said first and second armatures, respectively either side of the second armature, each of the third and fourth elastomer bodies being secured to both the first and second armatures;
the third and fourth elastomer bodies extend substantially in a second direction substantially perpendicular to the first direction.

Furthermore, an additional subject of the invention is a torque take-up link, comprising an antivibration device as defined hereinabove.

Other features and advantages of the invention will appear during the following description of three of its embodiments, given as non-limiting examples, with respect to the attached drawings.

### DESCRIPTION OF THE DRAWINGS

In the drawings:

FIG. 1 is a schematic view of an antivibration device according to one embodiment of the invention, serving to connect a torque take-up link to the body of a vehicle,

FIG. 2 is a schematic view of a cross-section of an antivibration device according to a first embodiment of the invention, usable for example in the application shown in FIG. 1,

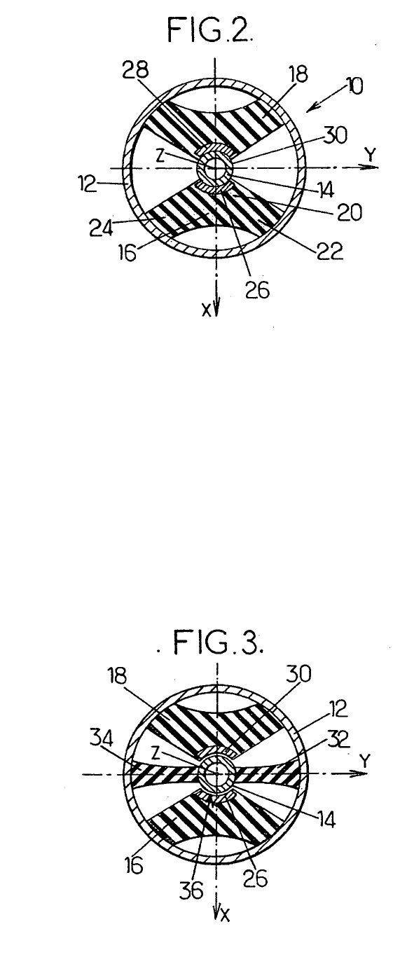

and FIG. 3 is view similar to FIG. 2, representing a second embodiment of the invention.

### DETAILED DESCRIPTION OF THE INVENTION

In the various figures, the same reference numbers indicate identical or similar elements.

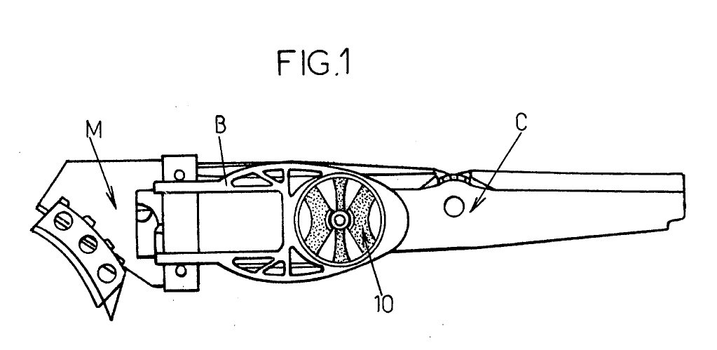

FIG. 1 shows a vehicle power train M which is connected to the body C of the said vehicle particularly via a torque take-up link B. One of the ends of the link rod B is connected to the body C via an antivibration device 10 according to one embodiment of the invention, the other end of the link rod comprising another antivibration sleeve able to be for example of known type, connected to the engine.

A first embodiment of the abovementioned antivibration device 10 is represented in FIG. 2. This antivibration device 10 is in the form of a sleeve and comprises first and second armatures which surround one another. More particularly, in the example in FIG. 2, the antivibration device 10 comprises an external tubular armature 12 and an internal tubular armature 14 surrounded by the external armature 12. These armatures 12, 14 are made of a rigid material, usually of metal. As represented in FIG. 2, the armatures 12, 14 are centred on one and the same central axis Z.

Furthermore, the device 10 also comprises first and second elastomer bodies 16, 18 which may, where necessary, form a single elastomer piece and which are situated either side of the internal armature 14 and inside the external armature 12. Each of these elastomer bodies 16, 18 is secured to the external armature 12. Each of the elastomer bodies 16, 18 is here in chevron form, that is to say in the form of a V whose point 20 is directed towards the internal armature 14 and whose two other ends 22, 24 are attached to the internal surface of the external armature 12, particularly by adherization. These two bodies 16, 18 are placed substantially symmetrically relative to a median plane containing the abovementioned axis Z and an axis Y perpendicular to the axis Z.

The point 20 of each elastomer body 16, 18 comprises an intermediate armature 26, 28 adjacent to the internal armature 14, which bears on the latter in the absence of stresses, without for all that being attached to the said internal armature. This intermediate armature 26, 28 is made of a rigid material, such as metal. As represented, the intermediate armature 26, 28 has a bearing surface 30 of a shape complementing that of the internal armature 14, that is to say, in this case, an arc of a circle. The length of the intermediate armature 26 is equal to that of the surface of the elastomer body 16 to which it is attached.

When the device 10 sustains no stress, the intermediate armatures 26, 28 of the elastomer bodies 16, 18 bear against the external surface of the internal armature 14.

When a force is applied between the first and second armatures along an axis X perpendicular to the abovementioned axes Y, Z, for example in a first alignment tending to compress the elastomer body 16, the elastomer body 18 remains immobile, the intermediate armature 28 not being attached to the internal armature 14. Similarly, when a force is applied in the direction X but in a second alignment opposite the first alignment, the elastomer body 16 remains immobile while the elastomer body 18 is compressed.

This prevents one of the elastomer bodies 18 from sustaining a traction force when the other elastomer body 16 sustains a compression force and consequently this increases the service life of the elastomer bodies.

In addition, the intermediate element 26, 28 increases the rigidity of the antivibration device along the axis X. It also makes it possible to have a greater range of linearity, that is to say to have a substantially stable rigidity of the device for various stresses.

The elastomer bodies 16, 18 being completely independent of one another, it could, where necessary, be possible to make them out of different elastomers according to the stress alignment of the device.

The second embodiment of the invention represented in FIG. 3 is similar to the first embodiment described hereinabove and will therefore not be described in detail here; only the differences relative to the first embodiment will be detailed.

In FIG. 3, there is a clearance 36 between the intermediate armatures 26, 28 and the internal armature 14, in the absence of stress. Thus the internal armature 14 bears against the intermediate armature 26, 28 only when one of the two armatures moves over a distance at least equal to the existing clearance 36. This clearance 36 means that the intermediate armatures 26, 28 are not stressed during slight movements of the internal armature 14 about its point of equilibrium, and therefore means that movement is not transmitted to the external armature 12 by the elastomer bodies 16, 18.

In similar manner, the clearance may be arranged between each intermediate armature and the external armature of an antivibration device of the type represented in FIG. 3.

In another embodiment, illustrated in FIG. 3, the device 10 comprises a third and a fourth elastomer body 32, 34, housed between the internal armature and the external armature and adherized to each of them in diametrically opposed manner relative to the internal armature, and situated along an axis perpendicular to that of the elastomer bodies 16, 18. This filtering element 32 is used to absorb the vibrations during the movement of the internal armature 14, but with a lesser force, and without stressing the intermediate armatures, if there is a clearance 36 as described previously.

It is also possible, thanks to the device 10 according to the invention, to create a vibrating mass formed by the intermediate element 26, 28, 27, 29 and the elastomer body 16, 18. That is to say that the elasticity of the elastomer body 16, 18 and the mass of the intermediate element 26, 28, 27, 29 are computed so as to obtain a vibrating mass which is used, by resonance effect, to obtain a desired response curve as a function of the frequency of vibration.

1. Antivibration device comprising a first annular armature surrounding a second armature, the armatures defining between them a free space, at least a first elastomer body being placed at least partially in the free space between the first and second armatures, the first body being secured to the first armature, the first elastomer body also being secured to a first intermediate armature which is adjacent to the second armature, wherein that the intermediate armature has a bearing surface suitable for bearing against a bearing surface of complementary shape belonging to the second armature, and the intermediate armature being suitable for bearing against the said second armature when the first and second armatures move relative to one another in a first direction, in a first alignment corresponding to a compression of the said first elastomer body, the said first intermediate armature being free relative to the second armature and being suitable for separating itself from the said second armature when the first and second armatures move one relative to the other in a second alignment opposite the said first alignment.

2. Device according to claim 1, wherein in that the device also comprises a second elastomer body which is placed in the free space between the first and second armatures, the first and second elastomer bodies being placed respectively either side of one of the first and second armatures the said second body being secured to the first armature and to a second intermediate armature which is adjacent to the second armature and which is suitable for bearing against the said second armature when the first and second armatures move relative to one another in the said second alignment, the said second intermediate armature being free relative to the second armature and being suitable for separating itself from the said second armature when the first and second armatures move relative to one another in the first alignment.

3. Device according to claim 1, wherein the intermediate armature is in contact with the second armature in the absence of external stress.

4. Device according to claim 1, wherein a clearance is made between the intermediate armature and the second armature, in the absence of external stress.

5. Device according to claim 2, wherein a clearance is made between the intermediate armature and the second armature, in the absence of external stress.

6. Device according to claim 2, wherein the first and second armatures are connected together also by third and fourth elastomer bodies which are housed at least partly in the free space between the said first and second armatures, respectively either side of the second armature, each of the third and fourth elastomer bodies being secured to both the first and second armatures.

7. Device according to claim 6, wherein the third and fourth elastomer bodies extend substantially in a second direction substantially perpendicular to the first direction.

8. Torque take-up link comprising at least at one of its ends an antivibration device according the claim 1.
